(19) United States
(12) Patent Application Publication
(10) Pub. No.: US 2025/0273878 A1
(43) Pub. Date: Aug. 28, 2025

(54) CONNECTOR

(71) Applicant: Yazaki Corporation, Tokyo (JP)

(72) Inventors: Akiyoshi TAKAGI, Shizuoka (JP); Tomoharu SUZUKI, Shizuoka (JP); Takuro SHIMADA, Shizuoka (JP)

(73) Assignee: Yazaki Corporation, Tokyo (JP)

(21) Appl. No.: 19/056,878

(22) Filed: Feb. 19, 2025

(30) Foreign Application Priority Data
Feb. 26, 2024 (JP) 2024-026310

(51) Int. Cl. H01R 4/34; H01R 13/74

(52) U.S. Cl. CPC H01R 4/34; H01R 13/748; H01R 2201/26

(57) ABSTRACT

A connector includes: a first terminal; a second terminal electrically connected to the first terminal; a screw member configured to electrically connect the first terminal and the second terminal by fastening and provided integrally with one terminal of the first terminal and the second terminal; and a nut rotatably and integrally assembled with the other terminal of the first terminal and the second terminal and fastened to the screw member.

### CROSS-REFERENCE TO RELATED APPLICATIONS

The present application is based on and claims the benefit of priority from the prior Japanese Patent Application No. 2024-026310, filed on Feb. 26, 2024, the entire contents of which are incorporated by reference herein.

### TECHNICAL FIELD

The disclosure relates to a connector.

### BACKGROUND

JP 2020-78971 A describes a connector including a bus bar as a first terminal, a motor terminal as a second terminal electrically connected to the bus bar, and a screw member for electrically connecting the bus bar and the motor terminal by fastening. In this connector, the screw member is fastened in a state where the bus bar and the motor terminal are overlapped with each other. By fastening the screw member, the bus bar and the motor terminal are brought into contact with each other, and the bus bar and the motor terminal are electrically connected to each other.

### SUMMARY

In the above connector, the screw member which is a separate component is fastened to the first terminal and the second terminal in a state where the first terminal and the second terminal are overlapped with each other. Therefore, it is necessary to manage and handle the screw member separately from managing and handling the first terminal and the second terminal, and the assemblability is low.

The disclosure is directed to a connector with improved assemblability.

A connector in accordance with some embodiments includes: a first terminal; a second terminal electrically connected to the first terminal; a screw member configured to electrically connect the first terminal and the second terminal by fastening and provided integrally with one terminal of the first terminal and the second terminal; and a nut rotatably and integrally assembled with the other terminal of the first terminal and the second terminal and fastened to the screw member.

According to the above configuration, the assemblability of the connector can be improved.

### BRIEF DESCRIPTION OF THE DRAWINGS

FIG. 1 is a perspective view of a connector according to an embodiment.

FIG. 2 is an exploded perspective view of the connector according to the embodiment.

FIG. 3 is a cross-sectional view of the connector according to the embodiment.

FIG. 4 is a cross-sectional view of the connector according to the embodiment when a second terminal is arranged in an inclined manner.

FIG. 5 is an enlarged view of a main part of FIG. 4.

FIG. 6 is a perspective view of a first housing of the connector according to the embodiment.

FIG. 7 is an exploded perspective view of the first housing of the connector according to the embodiment.

FIG. 8 is a perspective view of a second housing of the connector according to the embodiment.

FIG. 9 is an exploded perspective view of the second housing of the connector according to the embodiment.

FIG. 10 is a perspective view of a cover of the connector according to the embodiment.

FIG. 11 is an exploded perspective view of the cover of the connector according to the embodiment.

### DETAILED DESCRIPTION

Hereinafter, a connector 1 according to an embodiment will be described in detail with reference to the drawings. Note that dimensional ratios in the drawings are exaggerated for convenience of description, and may be different from the actual ratios.

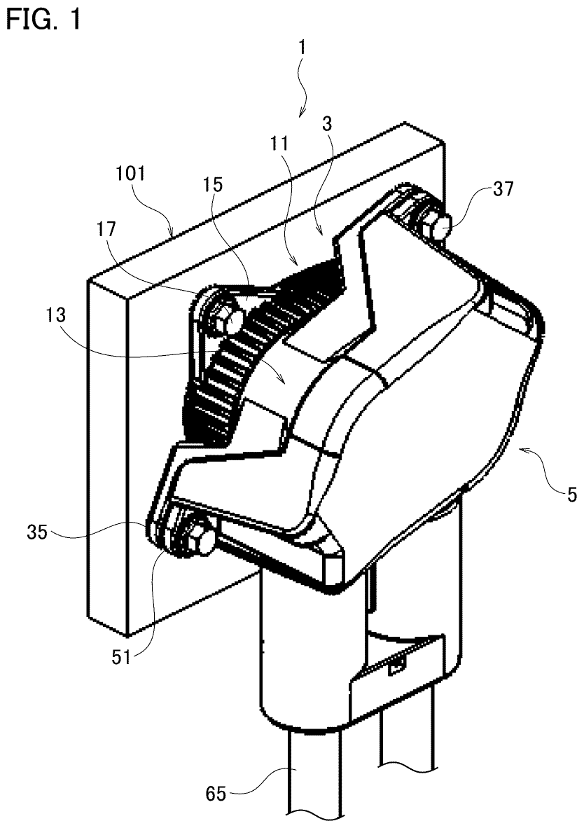

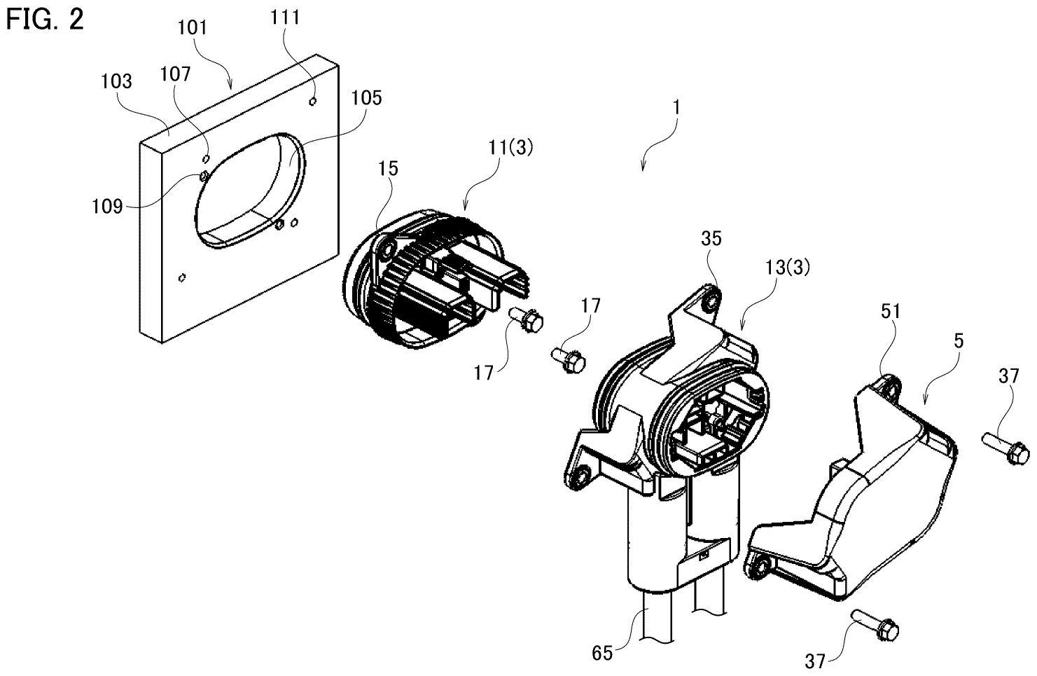

As illustrated in FIG. 1, the connector 1 according to the present embodiment is applied to, for example, an electric component 101 mounted on a vehicle. The connector 1 electrically connects, for example, the electric component 101 and other electric components (not illustrated) mounted on the vehicle, such as a power supply and a device. As illustrated in FIGS. 1 to 3, in the electric component 101, for example, a mating terminal (not illustrated) is accommodated inside a casing 103. The casing 103 is provided with an arrangement portion 105 including a through hole which is formed through a wall where the mating terminal is arranged. The connector 1 is assembled to the arrangement portion 105, and the electric component 101 and the connector 1 are electrically connected to each other.

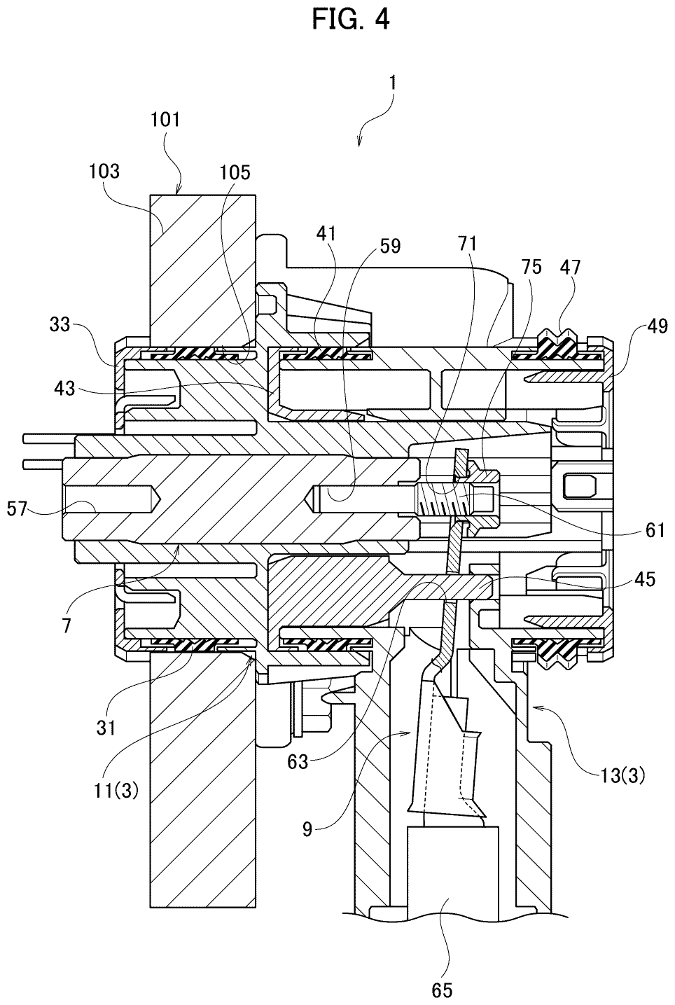

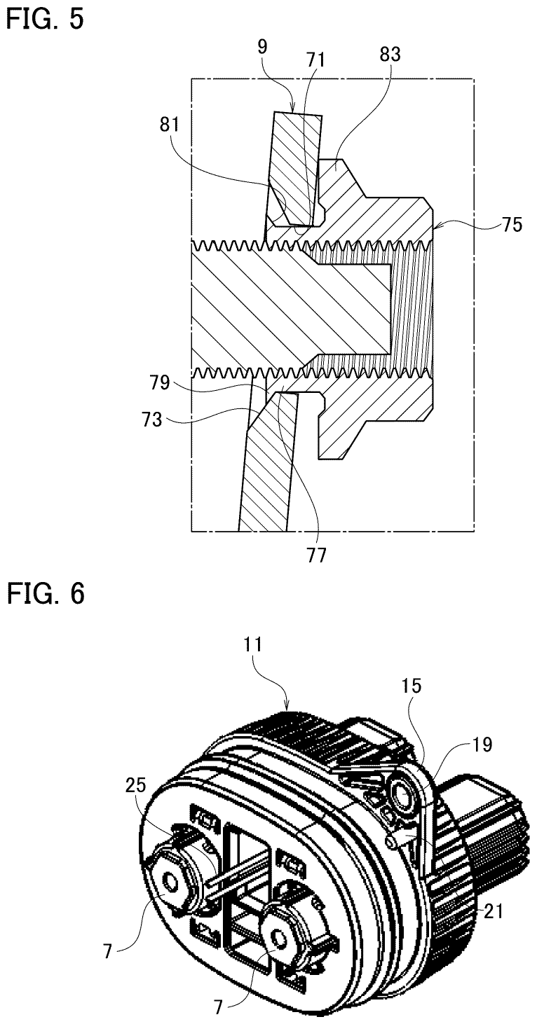

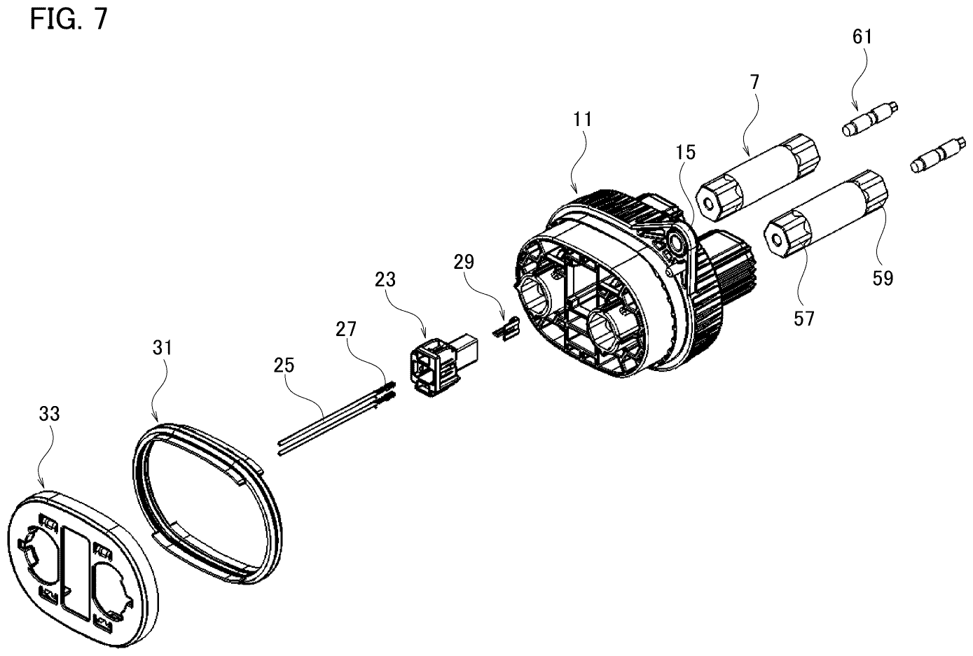

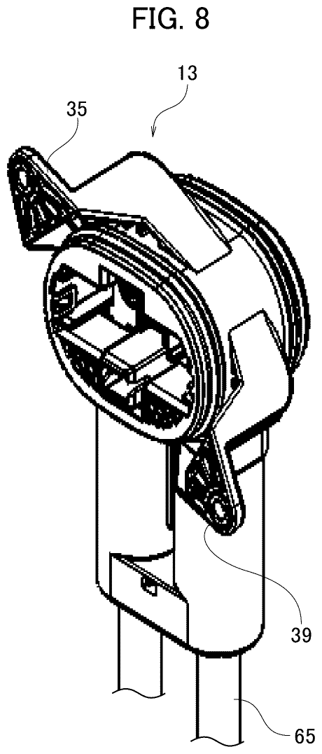

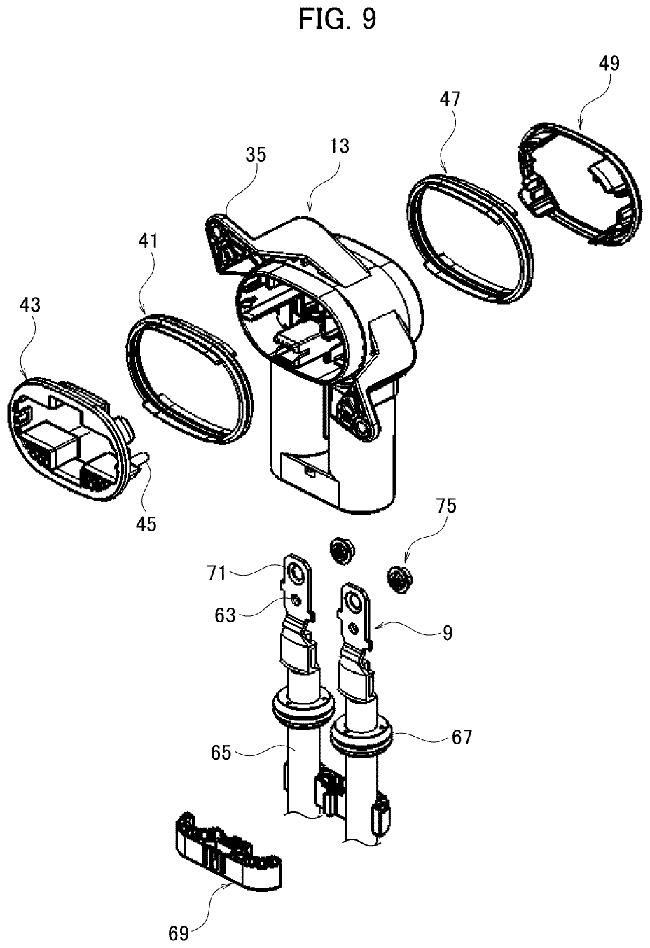

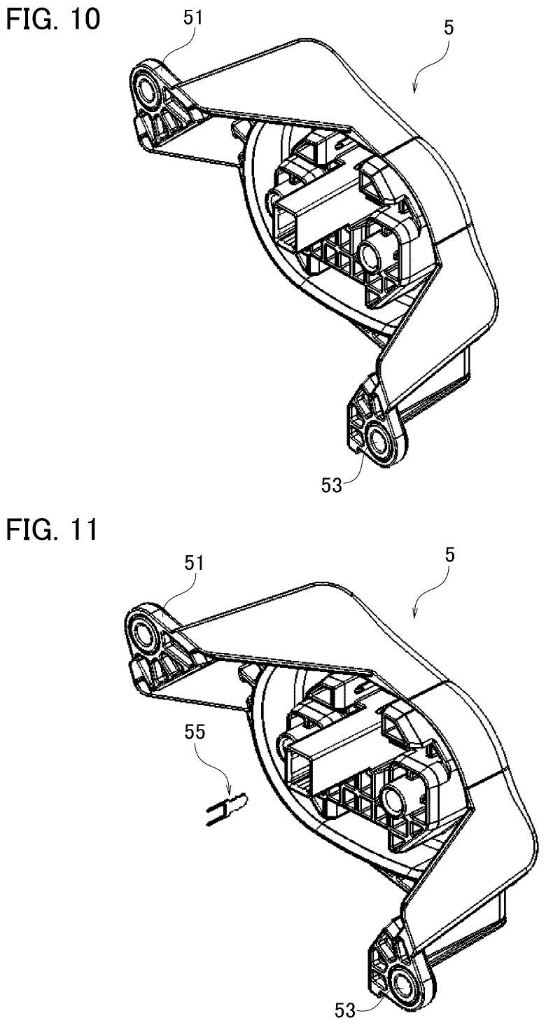

As illustrated in FIGS. 1 to 11, the connector 1 includes a housing 3, a cover 5, a first terminal 7, and a second terminal 9.

As illustrated in FIGS. 1 to 4, the housing 3 includes a first housing 11 and a second housing 13.

As illustrated in FIGS. 1 to 4, 6, and 7, the first housing 11 is formed of, for example, an insulating material such as a synthetic resin. The first housing 11 is formed in a tubular shape partially insertable into the arrangement portion 105 of the electric component 101. On the outer circumference of the first housing 11, a plurality of (two in the present embodiment) component fixers 15 protruding from the arrangement portion 105 of the electric component 101 to the outer diameter side are provided. A collar 19 into which a bolt 17 to be fastened to a screw hole 107 provided in the casing 103 of the electric component 101 is inserted is insert-molded in the component fixer 15. On a surface of the component fixer 15 facing the casing 103 of the electric component 101, a positioning pin 21 to be inserted into a positioning hole 109 provided in the casing 103 protrudes toward the casing 103. The component fixer 15 positions the first housing 11 with respect to the electric component 101 in a state where a part of the first housing 11 is inserted into the arrangement portion 105 of the electric component 101 by inserting the positioning pin 21 into the positioning hole 109. The component fixer 15 fixes the first housing 11 to the electric component 101 by fastening the bolt 17 to the screw hole 107 via the collar 19.

An inner housing 23 is accommodated in the first housing 11 from the electric component 101 side. The inner housing 23 is formed of, for example, an insulating material such as a synthetic resin. The inner housing 23 is held inside the first housing 11 via engaging portions (not illustrated) that engage with each other. The inner housing 23 accommodates, for example, a plurality of (two in the present embodiment) signal terminals 27 electrically connected to terminal portions of a plurality of (two in the present embodiment) signal lines 25 electrically connected to the electric component 101. A terminal holder 29 that holds the signal terminal 27 therein is assembled to the inner housing 23. Note that a locking lance that engages with the signal terminal 27 and holds the signal terminal 27 may be provided inside the inner housing 23. A packing 31 is assembled in close contact with the outer circumference of the first housing 11 on the electric component 101 side. The packing 31 is held on the first housing 11 by a front holder 33 assembled to the first housing 11 via engagement portions (not illustrated) that engage with each other. The packing 31 is in close contact with the casing 103 of the electric component 101 in a state where the first housing 11 is assembled to the electric component 101, and seals between the first housing 11 and the electric component 101. A plurality of (two in the present embodiment) the first terminals 7 are accommodated in the first housing 11 from the side opposite to the electric component 101.

As illustrated in FIGS. 1 to 4, 8, and 9, the second housing 13 is formed of, for example, an insulating material such as a synthetic resin. The second housing 13 has an upper portion formed in a tubular shape into which a part of the first housing 11 can be fitted, and a lower portion formed in a tubular shape communicating with the upper portion and extending in a direction orthogonal to the direction of fitting between the first housing 11 and the second housing 13. A plurality of (two in the present embodiment) the second terminals 9 are inserted into the lower portion of the second housing 13 from below, and the plurality of second terminals 9 are accommodated in the upper portion of the second housing 13. On the outer circumference of the upper portion of the second housing 13, a plurality of (two in the present embodiment) component fixers 35 protruding from the arrangement portion 105 of the electric component 101 to the outer diameter side are provided. A collar 39 into which a bolt 37 to be fastened to a screw hole 111 provided in the casing 103 of the electric component 101 is inserted is insert-molded in the component fixer 35. The component fixer 35 fixes the second housing 13 to the electric component 101 by fastening the bolt 37 to the screw hole 111 via the collar 39 in a state where the first housing 11 and the second housing 13 are fitted to each other. Note that the first housing 11 and the second housing 13 may be provided with engagement portions that engage with each other to hold the fitted state between the first housing 11 and the second housing 13.

A front packing 41 is assembled in close contact with the upper portion of the second housing 13 on the first housing 11 side. The front packing 41 is held on the second housing 13 by a front holder 43 assembled to the second housing 13 via engagement portions (not illustrated) that engage with each other. In the front holder 43, a plurality of (two in the present embodiment) holding pins 45 protrude toward the second terminal 9 accommodated in the second housing 13. The front packing 41 is in close contact with the first housing 11 in a state where the first housing 11 and the second housing 13 are fitted to each other, and seals between the first housing 11 and the second housing 13. A rear packing 47 is assembled in close contact with the upper portion of the second housing 13 on the cover 5 side. The rear packing 47 is held on the second housing 13 by a rear holder 49 assembled to the second housing 13 via engagement portions (not illustrated) that engage with each other. The rear packing 47 is in close contact with the cover 5 in a state where the second housing 13 is covered with the cover 5, and seals between the second housing 13 and the cover 5.

As illustrated in FIGS. 1, 2, 10, and 11, the cover 5 is formed of, for example, an insulating material such as a synthetic resin. The cover 5 covers the outer circumference of the upper portion of the second housing 13 on the side opposite to the electric component 101, and is formed in a shape capable of closing the opening of the second housing 13. On the outer circumference of the cover 5, a plurality of (two in the present embodiment) component fixers 51 protruding from the arrangement portion 105 of the electric component 101 to the outer diameter side are provided at the same positions as the component fixers 35 of the second housing 13. A collar 53 into which the bolt 37 to be fastened to the screw hole 111 provided in the casing 103 of the electric component 101 is inserted is insert-molded in the component fixer 51. The component fixer 51 fixes the cover 5 to the electric component 101 by fastening the bolt 37 to the screw hole 111 via the collar 53 in a state where the cover 5 covers the second housing 13. By providing the component fixers 51 at the same positions as the component fixers 35 of the second housing 13, the cover 5 can be fixed by the same bolt 37, and the number of components can be reduced. Note that the second housing 13 and the cover 5 may be provided with engagement portions that engage with each other to hold a state where the cover 5 covers the second housing 13. The cover 5 accommodates a short terminal 55 that electrically connects a plurality of (two in the present embodiment) the signal terminals 27 accommodated in the first housing 11, for example, by press fitting or the like. When the cover 5 is assembled to the electric component 101, the short terminal 55 electrically connects the plurality of signal terminals 27, and detects that the cover 5 is normally assembled to the electric component 101.

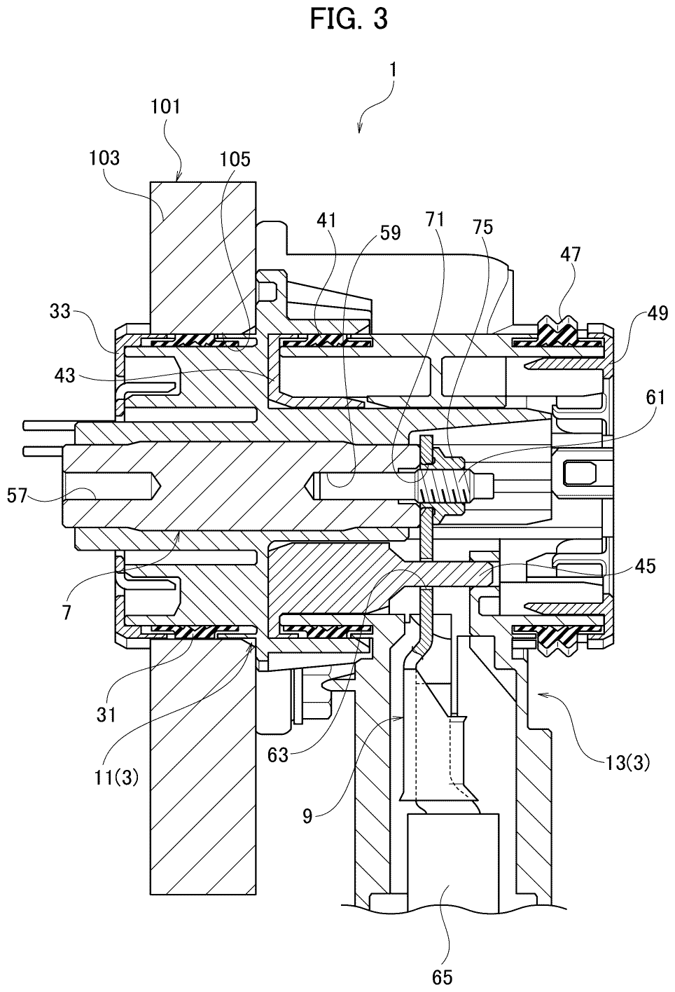

As illustrated in FIGS. 3, 4, and 7, the first terminal 7 is formed of a conductive material, and is formed, for example, in a columnar shape. The plurality of (two in the present embodiment) the first terminals 7 are accommodated in the first housing 11. The arrangement position of the first terminals 7 with respect to the first housing 11 is held, for example, by press fitting. Mating connectors 57 and terminal connectors 59 each formed by screw holes are provided on both end sides of the first terminals 7. For example, a mating screw member (not illustrated) formed of a stud bolt is fastened to the mating connector 57, and is integrally fixed with the first terminal 7. The mating terminal of the electric component 101 is arranged on the mating screw member, and a mating nut (not illustrated) is fastened to the mating screw member. By fastening the mating nut to the mating screw member, the mating terminal and the first terminal 7 come into contact with each other, and the mating terminal and the first terminal 7 are electrically connected to each other.

For example, a screw member 61 formed of a stud bolt is fastened to the terminal connector 59, and the screw member 61 is integrally fixed to the first terminal 7. By fixing the screw member 61 to the first terminal 7, the screw member 61 can be handled as one member with the first terminal 7, and the number of components can be reduced, whereby management and handling can be simplified. Note that the screw member 61 may be formed into one member continuous with the first terminal 7, for example, by forming the end portion of the first terminal 7 on the terminal connector 59 side in a columnar shape, and forming the outer circumference of the columnar portion in a screw shape. The second terminal 9 is arranged on the screw member 61.

As illustrated in FIGS. 3, 4, 5, and 9, the second terminal 9 is formed of a conductive material, and is formed, for example, in a plate shape. The plurality of (two in the present embodiment) second terminals 9 are accommodated in the second housing 13. In the second terminal 9, a pin hole 63 into which the holding pin 45 of the front holder 43 is inserted is provided through the second terminal 9. By inserting the holding pin 45 into the pin hole 63, the arrangement position of the second terminal 9 with respect to the second housing 13 is maintained. The plurality of second terminals 9 are electrically connected to, for example, terminal portions of a plurality of (two in the present embodiment) cables 65 electrically connected to other electric components (not illustrated) by crimping, welding, or the like. A rubber plug 67 is assembled in close contact with the outer circumference of the cable 65 on the second terminal 9 side. The rubber plug 67 is held to the second housing 13 by a lower holder 69 assembled to the second housing 13 via engagement portions (not illustrated) that engage with each other. The lower holder 69 is divided into two and assembled to the cable 65 via engaging portions (not illustrated) that engage with each other. By dividing the lower holder 69, the assembly position on the cable 65 can be freely determined, and the assemblability can be improved. The rubber plug 67 is in close contact with the second housing 13 in a state where the second terminal 9 is accommodated in the second housing 13, and seals between the second housing 13 and the cable 65.

The second terminal 9 is provided with an arrangement hole 71 formed through the second terminal 9 at a position corresponding to the screw member 61 of the first terminal 7 in a state where the first housing 11 and the second housing 13 are fitted to each other. An inclined surface 73 inclined so as to increase in diameter toward the first terminal 7 side is provided inside the arrangement hole 71. A nut 75 is arranged in the arrangement hole 71, and the nut 75 is integrally assembled with the second terminal 9 by, for example, caulking or the like.

The nut 75 is provided with an insertion portion 77 arranged inside the arrangement hole 71. An outer diameter of the insertion portion 77 is set to be smaller than an inner diameter of the small-diameter portion of the arrangement hole 71, and the nut 75 is rotatable with respect to the second terminal 9. The nut 75 can be inclined with respect to the second terminal 9 by setting the outer diameter of the insertion portion 77 to be smaller than the inner diameter of the small-diameter portion of the arrangement hole 71. A retaining portion 79 having a larger diameter than the small-diameter portion of the arrangement hole 71 is provided at an end portion of the insertion portion 77. An inclined surface 81 inclined so as to increase in diameter toward the second terminal 9 side is provided on the retaining portion 79. When the nut 75 is about to be detached from the second terminal 9, the inclined surface 81 abuts on the inclined surface 73 of the arrangement hole 71, and the retaining portion 79 prevents the nut 75 from being detached from the second terminal 9. The inclined surface 81 of the retaining portion 79 abuts on the inclined surface 73 of the arrangement hole 71, thereby restricting the inclination of the nut 75 with respect to the second terminal 9. By providing the inclined surface 73 in the arrangement hole 71 and providing the inclined surface 81 in the retaining portion 79, the length of the insertion portion 77 can be shortened, and the nut 75 can be downsized. A restrictor 83 having a diameter larger than the diameter of the arrangement hole 71 is provided in a portion of the nut 75 located outside the arrangement hole 71. The restrictor 83 is arranged at a position where a gap is formed between the restrictor 83 and an outer surface of the second terminal 9 in a state where the inclined surface 81 of the retaining portion 79 and the inclined surface 73 of the arrangement hole 71 abut each other. By forming a gap between the restrictor 83 and the outer surface of the second terminal 9, the nut 75 can be inclined with respect to the second terminal 9. When the nut 75 is about to be detached from the second terminal 9, the restrictor 83 abuts on the outer surface of the second terminal 9, thus preventing the nut 75 from being detached from the second terminal 9. The abutting of the restrictor 83 on the outer surface of the second terminal 9 restricts the inclination of the nut 75 with respect to the second terminal 9. Note that the retaining portion 79 and the restrictor 83 may be of any sizes as long as they are set to be larger than the diameter of the arrangement hole 71, and may be a plurality of protrusions or the like discontinuously arranged in the circumferential direction of the arrangement hole 71 without being continuous in the circumferential direction.

Note that it is also possible that the arrangement hole 71 is not provided with the inclined surface 73. In this case, the inner diameter of the arrangement hole 71 is formed uniformly over the thickness direction of the second terminal 9. Regarding such an arrangement hole 71, the insertion portion 77 may be formed in any size as long as the outer diameter is smaller than the inner diameter of the arrangement hole 71, and the length is longer than the thickness of the second terminal 9. The retaining portion 79 may be of any size and located at any position, as long as the retaining portion 79 has a diameter larger than the diameter of the arrangement hole 71 and is provided at the end portion of the insertion portion 77 exposed from the arrangement hole 71. The restrictor 83 may be arranged in any manner as long as a gap is formed between the restrictor 83 and the outer surface of the second terminal 9 in a state where the retaining portion 79 and the outer surface of the second terminal 9 abut each other. Even with the arrangement hole 71, the insertion portion 77, the retaining portion 79, and the restrictor 83 as described above, the nut 75 can be assembled in a rotatable and inclinable manner with respect to the second terminal 9.

The screw member 61 of the first terminal 7 is arranged on the nut 75 in a state where the first housing 11 and the second housing 13 are fitted to each other. At this time, when the screw member 61 and the nut 75 abut each other, and the second terminal 9 is inclined in the direction intersecting the axis of the screw member 61, the nut 75 is inclined in the direction intersecting the axis of the screw member 61. Therefore, the axis of the screw member 61 and the axis of the nut 75 can be arranged substantially on the same line. By fastening the nut 75 to the screw member 61 in a state where the nut 75 is arranged on the screw member 61, the first terminal 7 and the second terminal 9 come into contact with each other, and the first terminal 7 and the second terminal 9 are electrically connected to each other. By rotatably and integrally assembling the nut 75 with the second terminal 9, the nut 75 can be handled as one member with the second terminal 9, and the number of components can be reduced, whereby management and handling can be simplified. By rotatably assembling the nut 75 to the second terminal 9, the nut 75 can be fastened to the screw member 61 even when the screw member 61 is integrally provided with the first terminal 7. By arranging the nut 75 on the second terminal 9 so as to be able to incline in the direction intersecting the axis of the screw member 61, the nut 75 can incline when the second terminal 9 is arranged to incline with respect to the first terminal 7. When the nut 75 is inclined, the nut 75 can be arranged along the axis of the screw member 61. Therefore, the inclination of the second terminal 9 can be absorbed, and the nut 75 can be stably fastened to the screw member 61.

As an example of such assembly of the connector 1, first, the first housing 11, the second housing 13, and the cover 5 are each assembled.

In the assembling of the first housing 11, first, the signal terminal 27 provided at the terminal portion of the signal line 25 is accommodated in the inner housing 23, and the terminal holder 29 is assembled. Next, the inner housing 23 and the first terminal 7 are accommodated in the first housing 11. Next, the screw member 61 is fastened to the first terminal 7. The first terminal 7 to which the screw member 61 is fastened in advance may be accommodated in the first housing 11. Then, the packing 31 is mounted on the first housing 11, and the front holder 33 is assembled, thus completing the assembly of the first housing 11.

In the assembling of the second housing 13, first, the nut 75 is assembled to the second terminal 9, and the second terminal 9 is assembled to the end portion of the cable 65 on which the rubber plug 67 is mounted. Next, the second terminal 9 is accommodated in the second housing 13, and the lower holder 69 is assembled. Then, the front packing 41 and the rear packing 47 are mounted on the second housing 13, and the front holder 43 and the rear holder 49 are assembled, thus completing the assembly of the second housing 13.

In the assembly of the cover 5, the short terminal 55 is assembled to the cover 5, and the assembly of the cover 5 is completed.

In the assembling of the connector 1, first, the first housing 11 is arranged in the arrangement portion 105 of the electric component 101 so that the positioning pin 21 is inserted into the positioning hole 109. Next, the bolt 17 is inserted into the collar 19 of the component fixer 15 of the first housing 11, the bolt 17 is fastened to the screw hole 107, and the first housing 11 is assembled to the electric component 101. Next, the second housing 13 is arranged so that the first housing 11 is fitted inside the upper portion of the second housing 13. Next, the nut 75 is fastened to the screw member 61 to electrically connect the first terminal 7 and the second terminal 9. At this time, when the first housing 11 is arranged deep inside the second housing 13, the second terminal 9 may be inclined, but the inclination of the second terminal 9 can be absorbed by the nut 75 being inclined with respect to the second terminal 9. Next, the cover 5 is assembled to the second housing 13. Then, the bolt 37 is inserted into the collar 39 of the component fixer 35 of the second housing 13 and the collar 53 of the component fixer 51 of the cover 5, and the bolt 37 is fastened to the screw hole 111 to complete the assembly of the connector 1.

Such a connector 1 includes the first terminal 7, the second terminal 9 electrically connected to the first terminal 7, and the screw member 61 that electrically connects the first terminal 7 and the second terminal 9 by fastening. The screw member 61 is provided integrally with one of the first terminal 7 and the second terminal 9 (the first terminal 7 in the present embodiment). The nut 75 fastened to the screw member 61 is rotatably and integrally assembled with the other terminal (the second terminal 9 in the present embodiment) of the first terminal 7 and the second terminal 9.

Since the screw member 61 is provided integrally with the first terminal 7, the screw member 61 can be handled as one member with the first terminal 7. Therefore, the number of components can be reduced, and management and handling can be simplified. Since the nut 75 is rotatably and integrally assembled with the second terminal 9, the nut 75 can be handled as one member with the second terminal 9. Therefore, the number of components can be reduced, and management and handling can be simplified. By rotatably assembling the nut 75 to the second terminal 9, the nut 75 can be fastened to the screw member 61 even when the screw member 61 is integrally provided with the first terminal 7.

Therefore, in such a connector 1, it is not necessary to manage and handle the screw member 61 and the nut 75 separately from the first terminal 7 and the second terminal 9, and the assemblability can be improved.

The nut 75 is arranged so as to be able to incline with respect to the other terminal (the second terminal 9 in the present embodiment) in a direction intersecting the axis of the screw member 61.

Due to the inclination of the nut 75, the nut 75 can be arranged along the axis of the screw member 61, even if the second terminal 9 is arranged to be inclined with respect to the first terminal 7. Therefore, the inclination of the second terminal 9 can be absorbed, and the nut 75 can be stably fastened to the screw member 61.

The other terminal (the second terminal 9 in the present embodiment) is provided with the arrangement hole 71 formed through the second terminal 9. The nut 75 is provided with the insertion portion 77 having the outer diameter set to be smaller than the inner diameter of the arrangement hole 71 and arranged inside the arrangement hole 71, and the restrictor 83 having the diameter set to be larger than the diameter of the arrangement hole 71 and arranged outside the arrangement hole 71. A gap is formed between the restrictor 83 and the outer surface of the second terminal 9.

The nut 75 can be inclined with respect to the second terminal 9 in a rotatable manner by setting the outer diameter of the insertion portion 77 to be smaller than the inner diameter of the arrangement hole 71. By forming the gap between the restrictor 83 and the outer surface of the second terminal 9, the nut 75 can be inclined with respect to the second terminal 9. When the nut 75 is inclined, the abutting of the restrictor 83 on the outer surface of the second terminal 9 can restrict the inclination of the nut 75 with respect to the second terminal 9.

The retaining portion 79 having the diameter set to be larger than the diameter of the arrangement hole 71 is provided at an end portion of the insertion portion 77.

Therefore, the insertion portion 77 does not fall out of the arrangement hole 71, the nut 75 can be prevented from being detached from the second terminal 9, and the nut 75 can be stably held by the second terminal 9.

In the present embodiment, the screw member 61 is provided integrally with the first terminal 7, and the nut 75 is rotatably and integrally assembled with the second terminal 9, but the present invention is not limited thereto. For example, the screw member 61 may be provided integrally with the second terminal 9, and the nut 75 may be rotatably and integrally assembled with the first terminal 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A connector comprising:
a first terminal;
a second terminal electrically connected to the first terminal;
a screw member configured to electrically connect the first terminal and the second terminal by fastening and provided integrally with one terminal of the first terminal and the second terminal; and
a nut rotatably and integrally assembled with the other terminal of the first terminal and the second terminal and fastened to the screw member.

2. The connector according to claim 1, wherein the nut is arranged to be able to incline with respect to the other terminal in a direction intersecting an axis of the screw member.

3. The connector according to claim 2, wherein
the other terminal includes an arrangement hole penetrating the other terminal,
the nut includes
an insertion portion having an outer diameter smaller than an inner diameter of the arrangement hole and arranged inside the arrangement hole, and
a restrictor larger than a diameter of the arrangement hole and arranged outside the arrangement hole, and
a gap is formed between the restrictor and an outer surface of the other terminal.

4. The connector according to claim 3, wherein the insertion portion includes an end portion having a retaining portion larger than the diameter of the arrangement hole.
